(19) United States
(12) Patent Application Publication
(10) Pub. No.: US 2018/0300407 A1
(43) Pub. Date: Oct. 18, 2018

(54) Query Generation for Social Media Data

(71) Applicant: Runtime Collective Limited, Brighton (GB)

(72) Inventors: Adrian Szczepan Wolny, Stuttgart (DE); Julius Friedrich Wilhelm Dietz, Stuttgart (DE); Robert Mark Fletcher Rogers, Cambridge (GB)

(21) Appl. No.: 15/602,161

(22) Filed: May 23, 2017

Related U.S. Application Data
(60) Provisional application No. 62/485,012, filed on Apr. 13, 2017.

(51) Int. Cl. G06F 17/30; G06Q 50/00; G06N 5/02; G06N 99/00

(52) U.S. Cl. CPC G06F 17/30864; G06N 99/005; G06N 5/022; G06Q 50/01

(57) ABSTRACT

A first term is received as input to a social media data query. A related term is determined based on a predictive model trained on historical user interactions with a social media dataset of topics. The historical user interactions include query terms and associated topics returned as query results. The related term is provided to a user interface to prompt a user to include the related term in the social media data query. Related apparatus, systems, techniques and articles are also described.

### CROSS REFERENCE TO RELATED APPLICATION

This application claims priority under 35 U.S.C. § 119(e) to U.S. Provisional Patent Application No. 62/485,012 filed Apr. 13, 2017, the entire contents of which is hereby incorporated by reference herein.

### TECHNICAL FIELD

The subject matter described herein relates to query generation for social media data including, for example, tools for assisting a user to enhance a query based on related terms generated automatically in response to inputs from the user.

### BACKGROUND

The rise of social networks, in which peers directly communicate with one another (e.g., a peer-to-peer social network), presents new marketing opportunities. But social networks can include vast amounts of data that cannot be easily analyzed or visualized. Moreover, social networks are constantly in flux, with new interactions occurring and communities changing over even a short period of time further complicating network analysis.

Searching social media is likely to retrieve many documents that are not relevant to the intended search question. Such documents are called false positives. The retrieval of irrelevant documents is often caused by the inherent ambiguity of natural language.

Text clustering techniques based on unsupervised learning algorithms including Bayesian algorithms, Suffix Tree Clustering, k-means, and Gaussian Mixture Models can help reduce false positives. Clustering documents (e.g. text documents) returned for a given search term helps to identify relevant and off-topic documents. For a search term of “bank,” clustering can be used to categorize the document/data universe into “financial institution,” “place to sit,” “place to store,” and the like. Depending on the occurrences of words relevant to the categories, search terms or a search result can be placed in one or more of the categories.

However, even utilizing these techniques, searching social media data is likely to retrieve many irrelevant documents.

### SUMMARY

In an aspect, a first term is received as input to a social media data query. A related term is determined based on a predictive model trained on historical user interactions with a social media dataset of topics. The historical user interactions include query terms and associated topics returned as query results. The related term is provided to a user interface to prompt a user to include the related term in the social media data query.

One or more of the following features can be included in any feasible combination. For example, a distance between the first term and each of a plurality of clusters of social media datasets clustered according to predetermined labels can be determined. The distance can be calculated in a vector space. Determining the related term can be further based on one of the predetermined labels that are associated with a cluster that is a shortest distance to the first term in the vector space. Determining the related term can be based on a weighted combination of an output of the predictive model and the one of the predetermined labels that is associated with the cluster that is the shortest distance to the first term in the vector space. The clustered datasets can be clustered from a database of social media mentions including text documents relevant to the query.

The user interface can provide a query wizard interface to define the social media data query based on brands, products, and media terms. Attributes associated with the related term can be determined. The attributes can characterize whether the historical user interactions associated with the related term were associated with at least one of: hashtag, at mention, title, uniform resource locator, and author.

At least one of the receiving, the determining, and the providing can be performed by at least one data processor forming part of at least one computing system.

Non-transitory computer program products (i.e., physically embodied computer program products) are also described that store instructions, which when executed by one or more data processors of one or more computing systems, causes at least one data processor to perform operations herein. Similarly, computer systems are also described that may include one or more data processors and memory coupled to the one or more data processors. The memory may temporarily or permanently store instructions that cause at least one processor to perform one or more of the operations described herein. In addition, methods can be implemented by one or more data processors either within a single computing system or distributed among two or more computing systems. Such computing systems can be connected and can exchange data and/or commands or other instructions or the like via one or more connections, including a connection over a network (e.g. the Internet, a wireless wide area network, a local area network, a wide area network, a wired network, or the like), via a direct connection between one or more of the multiple computing systems, etc.

The details of one or more variations of the subject matter described herein are set forth in the accompanying drawings and the description below. Other features and advantages of the subject matter described herein will be apparent from the description and drawings, and from the claims.

### DESCRIPTION OF DRAWINGS

FIG. 1 is an illustration of an example user interface presenting a social media query wizard;

FIG. 2 illustrates an example interface that prompts a user to include or exclude relevant terms in their search;

FIG. 3 is an example interface for entering a search term;

FIG. 4 illustrates an interface showing related terms determined using clustering of social media datasets;

FIG. 5 illustrates an interface showing recommendations containing synonyms and terms that relate to a given term;

FIG. 6 is a process flow diagram illustrating a method of providing dynamic recommendations for improving a social media search;

FIG. 7 is a system block diagram illustrating an example social media query system for providing dynamic recommendations for improving a social media search query; and

FIGS. 8-11 illustrate a series of example interfaces for a user to interact with an example social media query system.

Like reference symbols in the various drawings indicate like elements.

### DETAILED DESCRIPTION

The current subject matter can include tools for assisting a user in enhancing a query on a social media database. In an example, a user can provide a first term or set of terms, such as a keyword or keyphrase, as an input, and the query enhancement tool can provide dynamic recommendations for improving the search query by adding a term or changing the user input term. The recommendations can be specific to social media content. Recommendations can be provided by utilizing predictive models trained on historical user interactions with a social media dataset. The predictive models can predict a context of a given query or input term.

In some implementations, the current subject matter applies to determining context for the keyword or keyphrase based on a database of social media topics. A predictive model trained on the query database can be used to suggest context for a given keyword or keyphrase. Synonyms and related terms and attributes derived from the social media database can be shown. These terms can be user selectable (e.g., by tapping, clicking, mousing over, and the like) to provide drill down information, allowing the user to add these terms to the query, and the like.

Dynamic recommendations of terms (e.g., to be added to or excluded from a search string being constructed) can be provided by models that learn and predict user interactions with the social media data set. The interactions can include the kind of queries being created, manual categorization of mentions from the social media dataset, the common use cases of users interacting with social media databases, and the like. As an example, a neural network or other artificial intelligence system can be trained. In some implementations, the training can be unsupervised (e.g., no supervisory signal from the user is used). In order to train such a network it is possible to look at previous queries created by the user and apply an inference or rule that words/terms that appear in the same query share semantic meaning. The network (e.g., model) learns to predict a word from its neighbor's words. As an example, if the user enters a keyphrase: ‘quick, brown’ the predicted target query term can be e.g., ‘fox’, if the user enters ‘brandname’ the model may predict ‘#brandnamefootball’ as a related hashtag in the social media. In some implementations, the predictive model can include a neural network trained to reconstruct linguistic contexts of words that has been used to write queries in the past. Thus, a model can be trained on what query terms and results a user finds relevant.

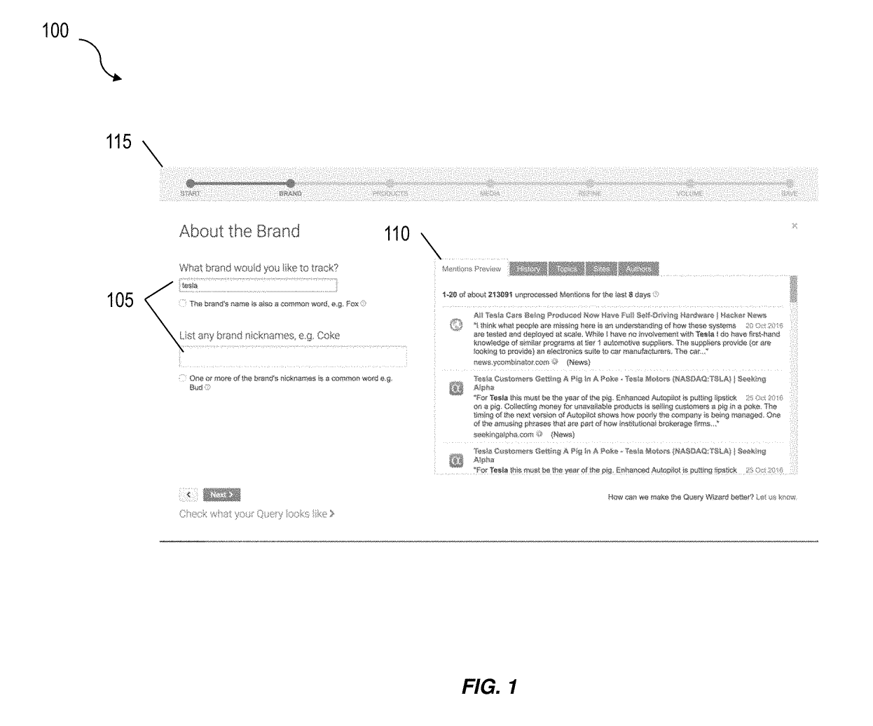

FIG. 1 is an illustration of an example user interface 100 presenting a social media query wizard. The social media query wizard enables users to build and execute queries on social media data. Social media data can include text documents (sometimes referred to as posts) from social networks such as TWITTER®, FACEBOOK®, FLICKR®, YOUTUBE®, INSTAGRAM®, and the like; blog posts from publicly visible blogging sites; news and articles from across the web that can be collected. The queries can relate to tracking brands such as tracking the number of social media posts mentions are associated with a particular brand. Social media posts that match a given query can be referred to as mentions. A mention can include a text document (e.g., post) that is relevant to a given query. Mentions can include any occurrence of the brand name or related term in a social media post by any author. A mention can be understood informally as a document on the web that ‘mention’ one or many of the terms included in the boolean query. The user interface 100 includes graphical user interface (GUI) objects 105 for entering initial terms for the brand and brand nicknames. Additional objects provide volume of results and most relevant mentions at 110.

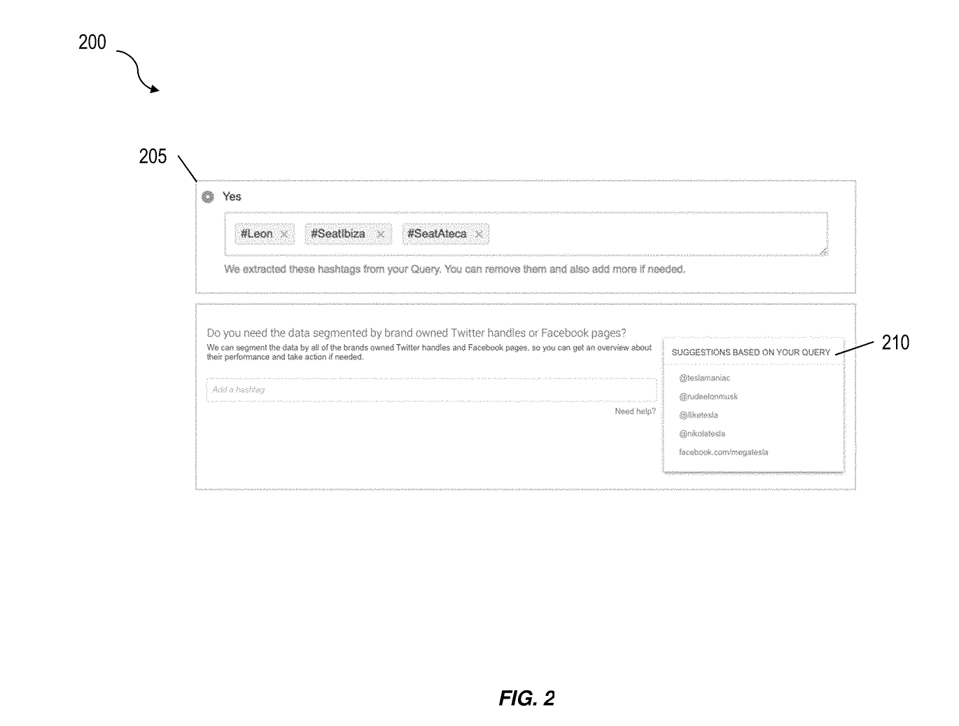

As illustrated at 115, the query wizard provides a number of steps that enables a user to craft a complex social media query that can include searching on one or more of brand name, products, and media channels. At each step of the query wizard, the user can be provided with relevant suggestions that can be used to enhance the query. The user can choose suggested terms to expand the query results (including the suggested terms in the query via boolean operators such as OR (e.g., set union)) or increase the precision of the query (e.g., by excluding the query results which contain suggested terms via boolean operators such as AND (e.g., set intersection) and NOT (e.g., set subtraction)). FIG. 2 illustrates an example interface 200 that prompts a user to include or exclude relevant terms in their search. The interface 200 includes a suggestion field 205 illustrating example hashtags that relate to the present query. The user can select the tags to add or exclude related datasets from the query results. The interface 200 also includes a second suggestion field 210 illustrating example “at mentions” for refining the query.

The result of the query wizard according to the current subject matter can include that the user is presented with a sophisticated query that provides social media data, such as mentions, that are relevant to the question the user is trying to answer.

The user can also be presented with different variants of the query. Such an approach can consider semantical and lexical variations of the terms used in the query as well as the query structure, which can be compared with high quality queries stored in a database. A user can pick a final query by exploring mentions and found topics.

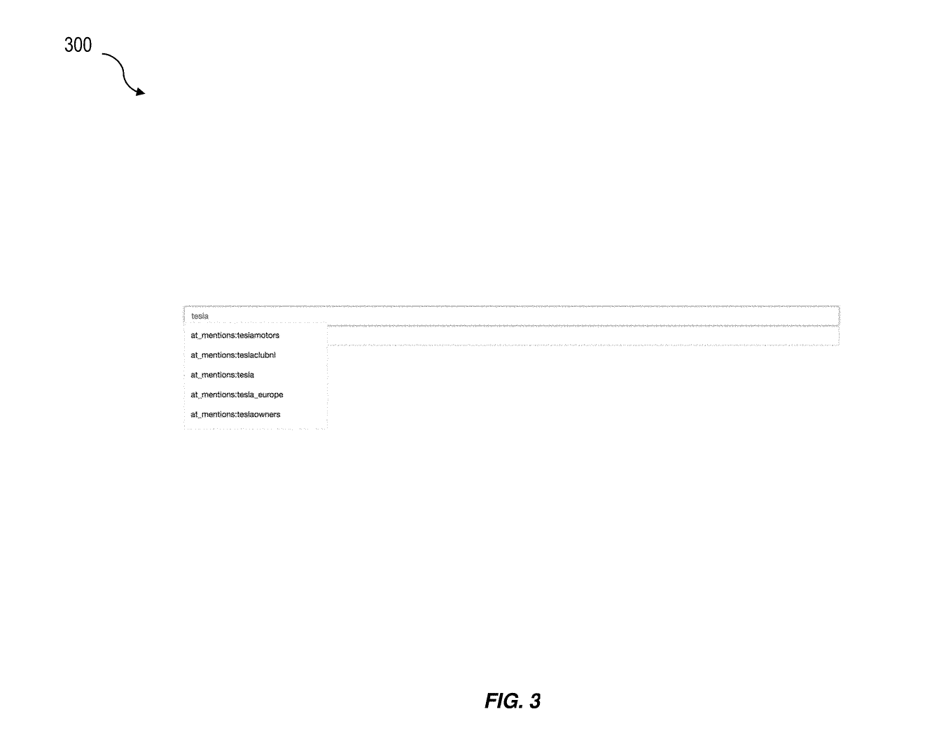

FIG. 3 is an example interface 300 for entering a search term. The interface 300 can auto-complete suggestions based on determined related terms. The suggestions can be based on popular and recent content learned from a social media query database.

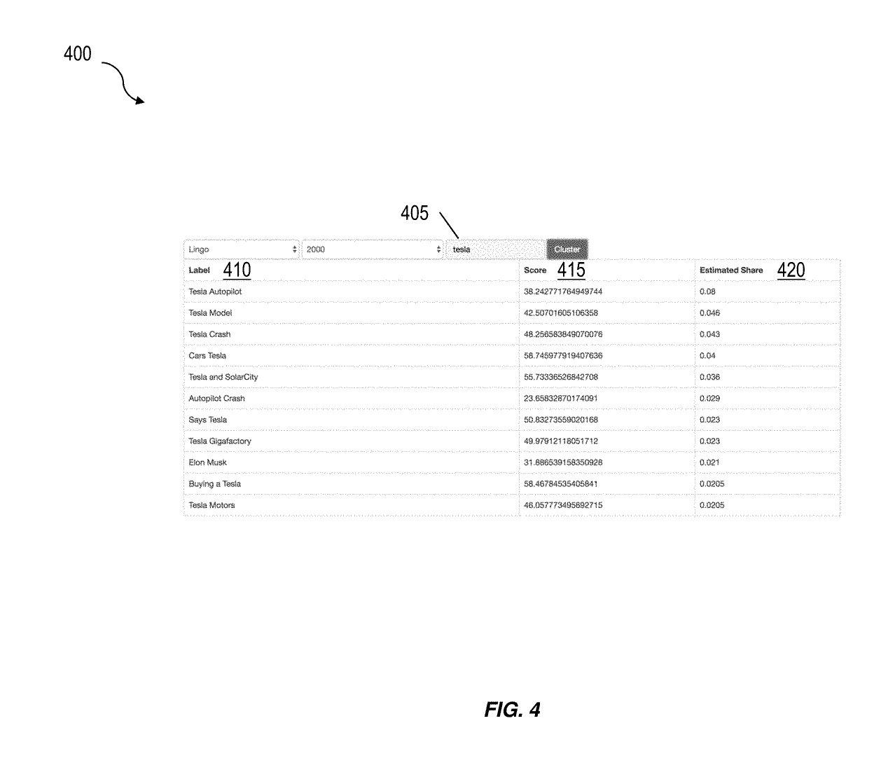

FIG. 4 illustrates an interface 400 showing related terms determined using clustering of social media datasets. The subset of the underlying social media dataset including the mentions relevant to a given keyword or keyphrase can be clustered using text clustering algorithms that create clusters of datasets (also referred to as documents). The datasets can be clustered according to predetermined labels. The labels can be an inferred topic. A topic can include a human readable label assigned to a cluster of documents, e.g., from each cluster of documents a term or phrase that best describes a given cluster can be extracted and presented as a topic to the user.

For example, as illustrated in FIG. 4, the search term 405 is “tesla” and related terms 410 are shown. The related terms are topics that correspond to a cluster of datasets. The illustrated score 415 is a measure of quality of a label and can be specific to the clustering algorithm that is implemented. The estimated share 420 can be the percent of documents in the social media database that belongs to each cluster.

In order to determine whether a cluster is related to a search term, both the search term and the clusters of datasets (having been previously determined) can be projected into a vector space. A vector space model (or vector model) is an algebraic model for representing text documents (and any objects, in general) as vectors of identifiers, such as, for example, index terms. Documents and queries are represented as vectors. Each dimension corresponds to a separate term. If a term occurs in the document, its value (or weight) in the vector is non-zero. A measure of distance between the vectors (e.g., the search term and each cluster) can be determined. The cluster with the shortest distance between the cluster and search term can be considered a relevant term (e.g., the label associated with the cluster) and provided to the user. In some implementations, the top n relevant terms are returned, where n is a predefined or predetermined value. In some implementations, all labels associated with clusters that are within a predefined distance can be considered relevant terms and provided to the user.

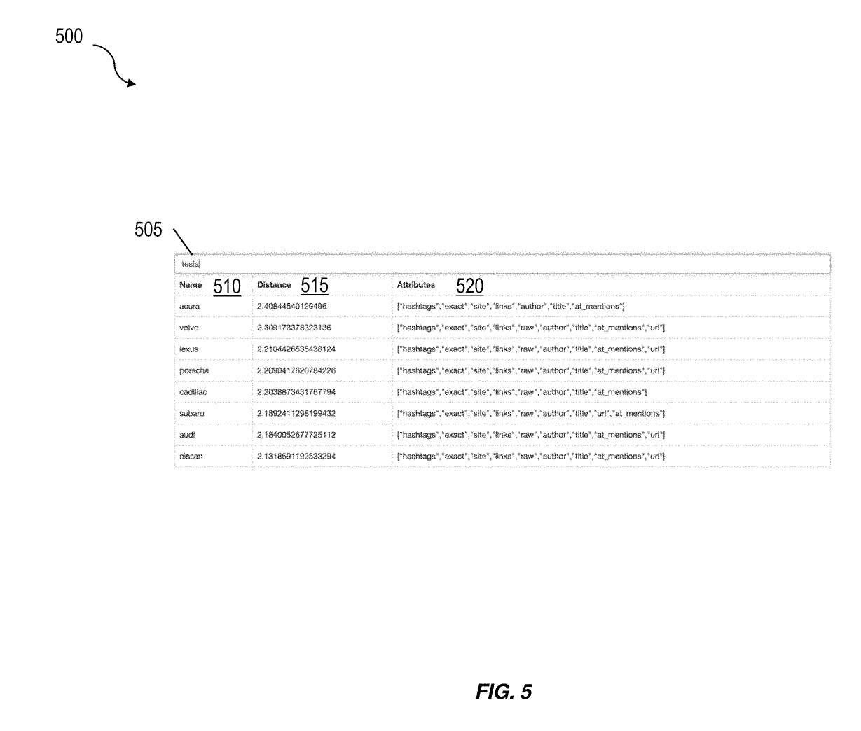

FIG. 5 illustrates an interface 500 showing recommendations containing synonyms and terms that relate to a given term. These recommendations can be based on historical user behaviors and interactions with a social media database. The interface 500 includes the search term 505 and related terms 510 that relate to the search term 505. The distance 510 can describe the vector space distance metric between the related term 510 and the search term 505. Attributes 515 can specify whether historical user interactions associated with the related term were associated with the attribute. For example, whether the previous user interaction related to hashtags, exact, site, links, author, title, at mentions, and the like.

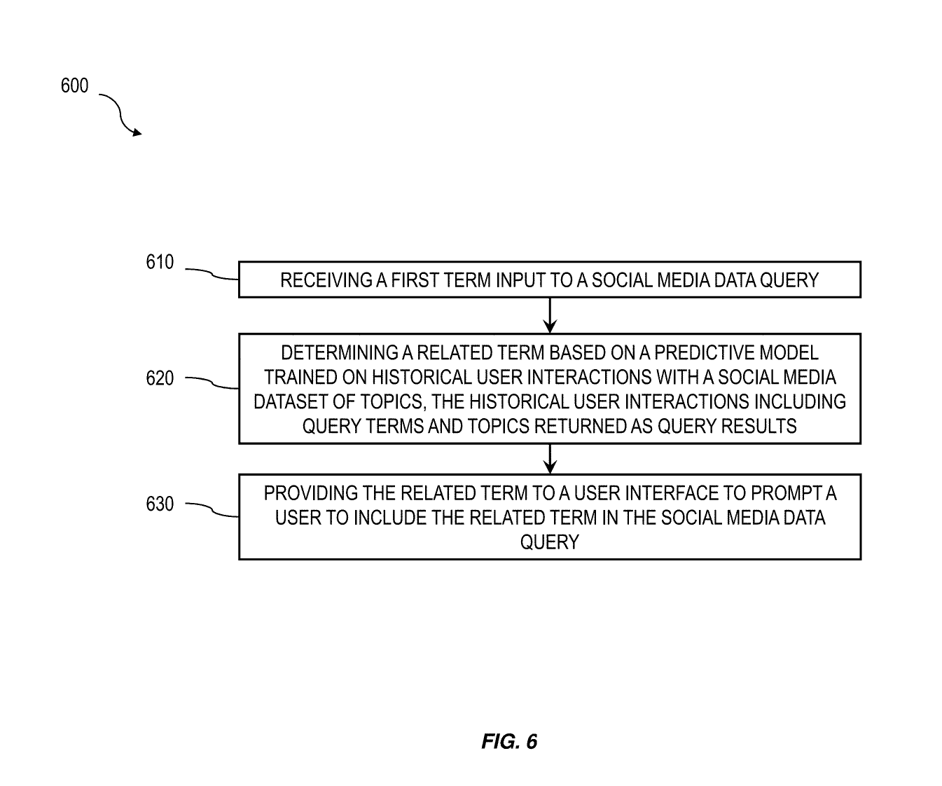

FIG. 6 is a process flow diagram illustrating a method 600 of providing dynamic recommendations for improving a social media search query. A method having at least some of these features can enable a user to receive useful information from a search for keyword or keyphrase in social media databases.

At 610, a first term can be received as input to a social media data query. The input may be received using a query wizard that enables creation of complex queries on social media datasets. The query wizard can be part of an interface to define the social media data query based on brands, products, and media terms.

At 620, a related term can be determined. The related term can be determined based on a predictive model trained on historical user interactions (e.g., queries) with a social media dataset of topics. The historical user interaction can include query terms and associated topics returned as query results.

In some implementations, determining the related term can include determining a distance between the first term and clusters of social media datasets or documents. The clusters of documents can be clustered according to predetermined labels. The distance can be determined in vector space, for example, as described in more detail above. At least the label of the closest cluster (e.g., the cluster having the shortest distance measure) to the search term can form a basis for determining the related term. For example, a weighted combination of an output of the predictive model and the label of at least the closest label can be used to determine the related term.

At 630, the related term can be provided to the user interface to prompt the user to include the related term in the social media data query. The prompting can be in many forms, for example, those illustrated in FIGS. 2 and 3.

Attributes of related terms can also be determined. The attributes can specify whether the historical user interactions associated with the related term were associated with a hashtag, at mention, title, uniform resource locator, author, and the like.

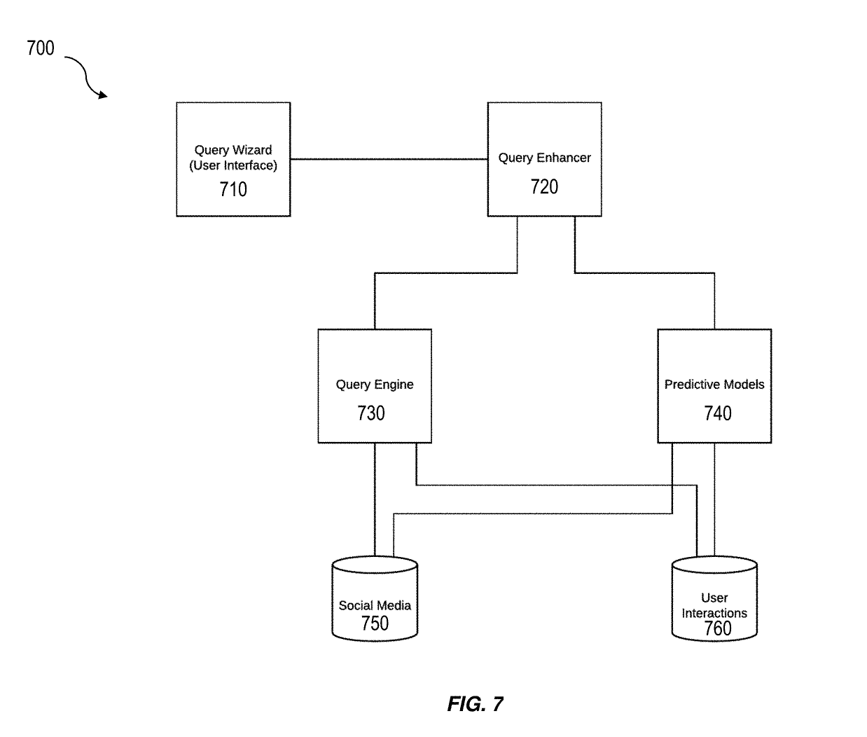

FIG. 7 is a system block diagram illustrating an example social media query system 700 for providing dynamic recommendations for improving a social media search query. The example social media system 700 can enable a user to receive useful information from a search for keyword or keyphrase in social media databases. The example social media query system 700 includes a query wizard 710, query enhancer 720, query engine 730, predictive models 740, social media database 750, and user interactions database 760.

Query wizard 710 can include a user interface that simplifies the process of complex boolean query building and shows dynamic recommendation of query terms returned from query enhancer 720.

Query enhancer 720 can provide dynamic recommendation of query terms based on single keyword search provided by the user and information obtained from the query engine 730 and predictive models 740.

Query engine 730 can provide term autocomplete functionality, return topics related to a keywords provided by the user, and execute search result clustering algorithms. Query engine 730 can use information received from social media database 750 and historical user interactions database 760 (e.g., for performing inference).

Predictive models 740 can include word embedding models that can provide synonyms and related context terms based on keywords provided by the user. These models can be constantly retrained by using data from social media database 750 and user interactions database 760.

Social media database 750 can include a database of social media posts (e.g., mentions) collected from the internet. User interactions database 760 can include a database of user interactions with the social media database 750 and can include queries previously created by the users as well as manual and automatic categorization of social media posts (e.g., mentions).

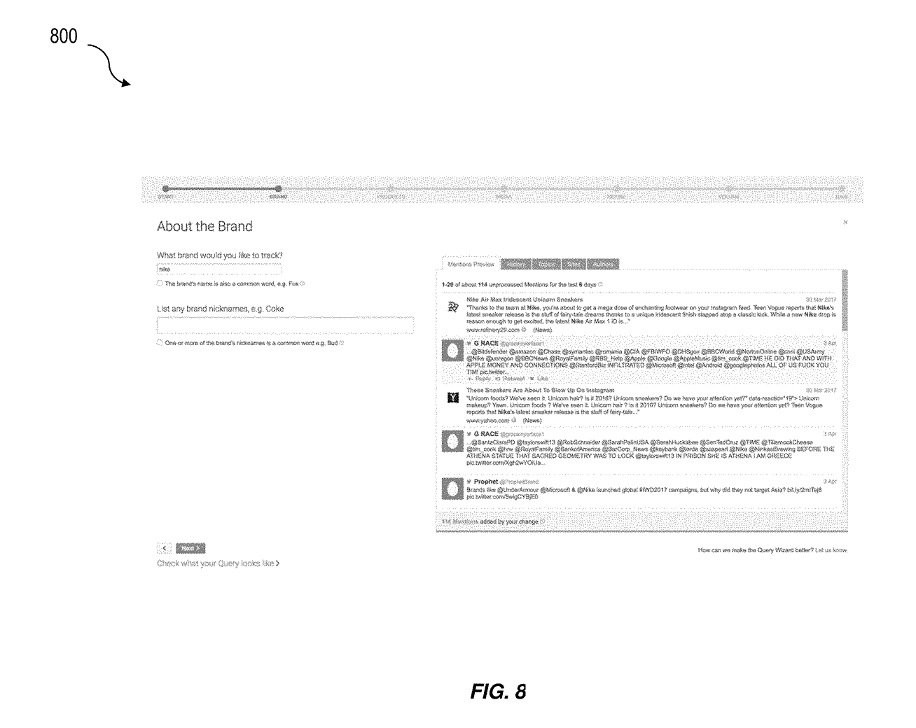

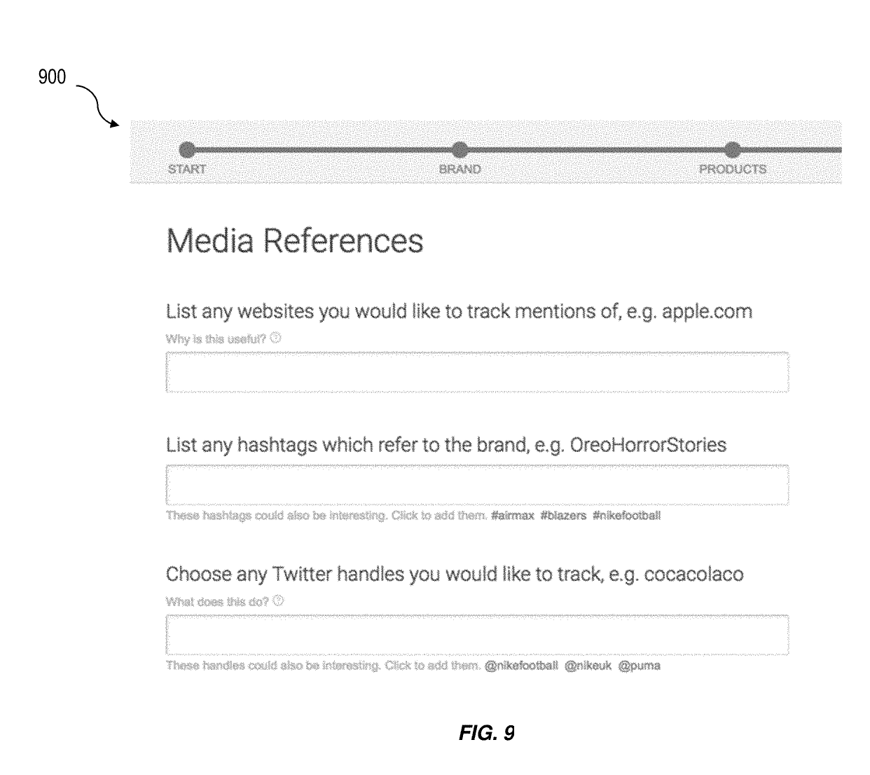

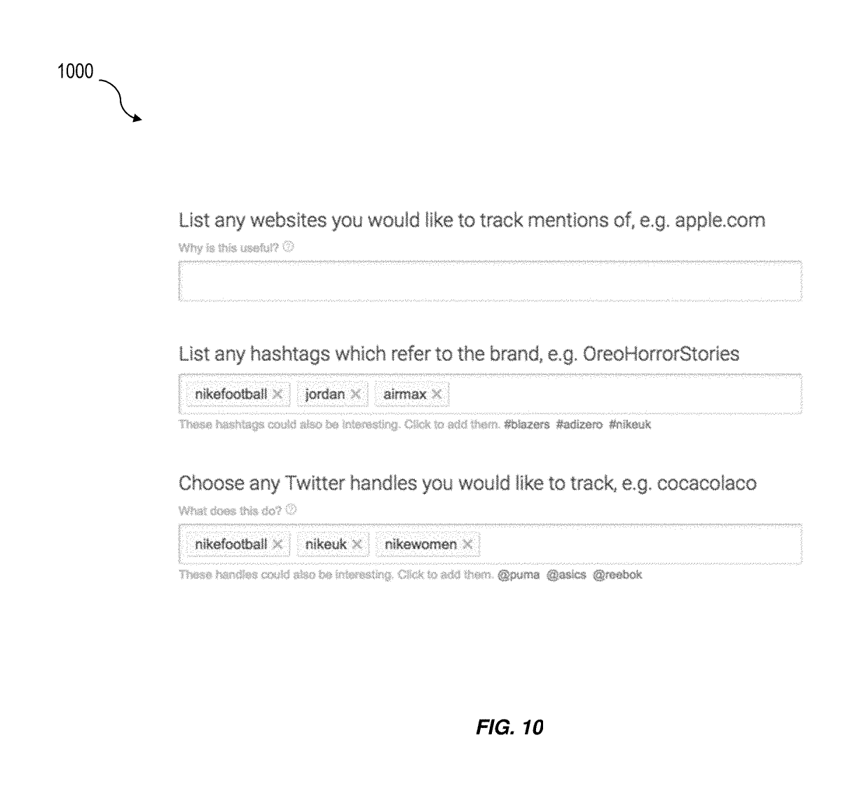

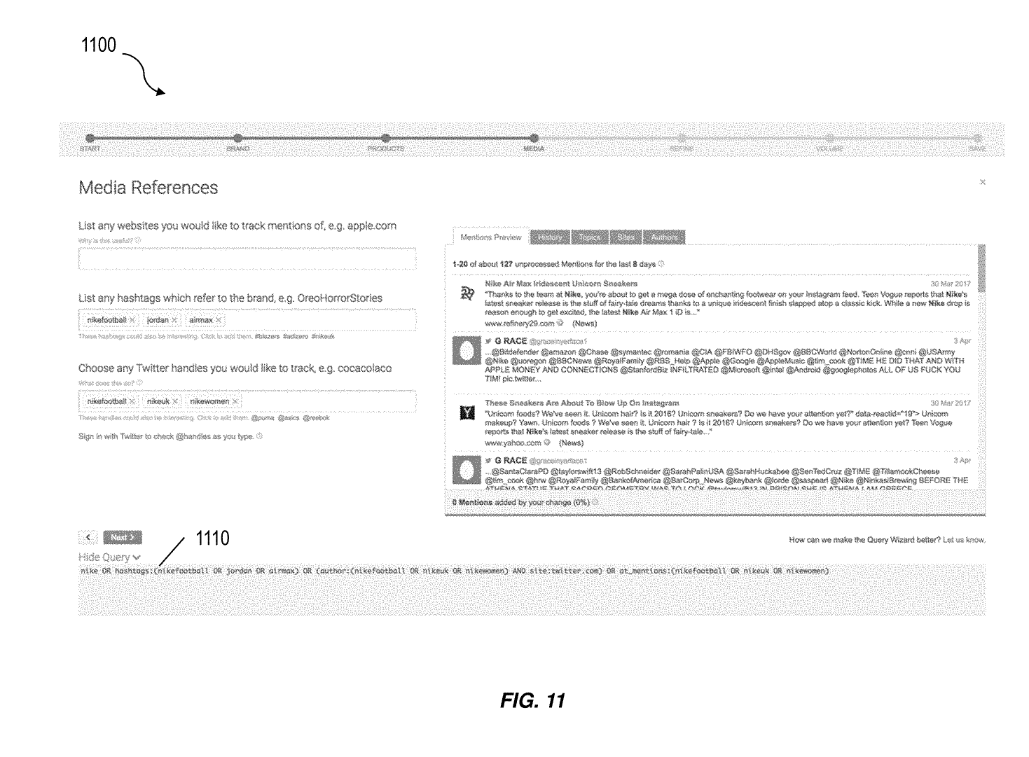

FIG. 8-11 illustrate a series of example interfaces for a user to interact with social media query system 700. FIG. 8 illustrates another example interface 800 for a query wizard 710. A single brand name can be provided by the user when the start open the query wizard user interface 710. FIG. 9 illustrates another example interface 900 that prompts a user with media references recommended by the social media query system 700. After providing the brand name in interface 800, the user can be provided in interface 900 with dynamic recommendations returned by the query enhancer 720 and based on the single brand name provided in interface 800. FIG. 10 illustrates another example interface 1000 in which recommendations are automatically added to the query when a user clicks on them. FIG. 11 illustrates another example interface 1100 in which a Boolean query 1110 is generated by the social media query system 700. At 1110, (bottom of interface 1100) the user is provided with a complex query generated by the query wizard

The subject matter described herein provides many technical advantages. For example, the subject matter described can enable a user to receive useful information from a search for keyword or keyphrase in social media databases. Using other approaches, a search for a term or group of terms can generate many hits having many different contexts that are not relevant to the intended context of the user's search. Further, it can be difficult to train the query to focus on the valuable terms in a search. A display of possible contexts associated with/related to initially input search terms/phrases allows the user the option to further build the query by adding or excluding contexts chosen from this set of possible contexts.

The current subject matter provides solutions to technical problems. In particular the current subject matter can enable better search queries and better search results providing an improved search computing system. Additionally, the current subject matter can enable a user interface providing improved user interaction for querying social media data.

One or more aspects or features of the subject matter described herein can be realized in digital electronic circuitry, integrated circuitry, specially designed application specific integrated circuits (ASICs), field programmable gate arrays (FPGAs) computer hardware, firmware, software, and/or combinations thereof. These various aspects or features can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device. The programmable system or computing system may include clients and servers. A client and server are generally remote from each other and typically interact through a communication network. The relationship of client and server arises by virtue of computer programs running on the respective computers and having a client-server relationship to each other.

These computer programs, which can also be referred to as programs, software, software applications, applications, components, or code, include machine instructions for a programmable processor, and can be implemented in a high-level procedural language, an object-oriented programming language, a functional programming language, a logical programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor. The machine-readable medium can store such machine instructions non-transitorily, such as for example as would a non-transient solid-state memory or a magnetic hard drive or any equivalent storage medium. The machine-readable medium can alternatively or additionally store such machine instructions in a transient manner, such as for example as would a processor cache or other random access memory associated with one or more physical processor cores.

To provide for interaction with a user, one or more aspects or features of the subject matter described herein can be implemented on a computer having a display device, such as for example a cathode ray tube (CRT) or a liquid crystal display (LCD) or a light emitting diode (LED) monitor for displaying information to the user and a keyboard and a pointing device, such as for example a mouse or a trackball, by which the user may provide input to the computer. Other kinds of devices can be used to provide for interaction with a user as well. For example, feedback provided to the user can be any form of sensory feedback, such as for example visual feedback, auditory feedback, or tactile feedback; and input from the user may be received in any form, including acoustic, speech, or tactile input. Other possible input devices include touch screens or other touch-sensitive devices such as single or multi-point resistive or capacitive trackpads, voice recognition hardware and software, optical scanners, optical pointers, digital image capture devices and associated interpretation software, and the like.

In the descriptions above and in the claims, phrases such as “at least one of” or “one or more of” may occur followed by a conjunctive list of elements or features. The term “and/or” may also occur in a list of two or more elements or features. Unless otherwise implicitly or explicitly contradicted by the context in which it is used, such a phrase is intended to mean any of the listed elements or features individually or any of the recited elements or features in combination with any of the other recited elements or features. For example, the phrases “at least one of A and B;” “one or more of A and B;” and “A and/or B” are each intended to mean “A alone, B alone, or A and B together.” A similar interpretation is also intended for lists including three or more items. For example, the phrases “at least one of A, B, and C;” “one or more of A, B, and C;” and “A, B, and/or C” are each intended to mean “A alone, B alone, C alone, A and B together, A and C together, B and C together, or A and B and C together.” In addition, use of the term “based on,” above and in the claims is intended to mean, “based at least in part on,” such that an unrecited feature or element is also permissible.

The subject matter described herein can be embodied in systems, apparatus, methods, and/or articles depending on the desired configuration. The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and subcombinations of the disclosed features and/or combinations and subcombinations of several further features disclosed above. In addition, the logic flows depicted in the accompanying figures and/or described herein do not necessarily require the particular order shown, or sequential order, to achieve desirable results. Other implementations may be within the scope of the following claims.

What is claimed is:

1. A method comprising:
receiving a first term as input to a social media data query;
determining a related term based on a predictive model trained on historical user interactions with a social media dataset of topics, the historical user interactions including query terms and associated topics returned as query results, the related term being related to the first term; and
providing the related term to a user interface to prompt a user to include the related term in the social media data query.

2. The method of claim 1, further comprising:
determining a distance between the first term and each of a plurality of clusters of social media datasets clustered according to predetermined labels, the distance calculated in a vector space,
wherein determining the related term is further based on one of the predetermined labels that is associated with a cluster that is a shortest distance to the first term in the vector space.

3. The method of claim 2, wherein determining the related term is based on a weighted combination of an output of the predictive model and the one of the predetermined labels that is associated with the cluster that is the shortest distance to the first term in the vector space.

4. The method of claim 2, wherein the clustered datasets are clustered from a database of social media mentions including text documents relevant to the query

5. The method of claim 1, wherein the user interface provides a query wizard interface to define the social media data query based on brands, products, and media terms.

6. The method of claim 1, further comprising:
determining attributes associated with the related term, the attributes characterizing whether the historical user interactions associated with the related term were associated with at least one of: hashtag, at mention, title, uniform resource locator, and author.

7. The method of claim 1, wherein at least one of the receiving, the determining, and the providing is performed by at least one data processor forming part of at least one computing system.

8. A system comprising: at least one data processor; and memory storing instructions, which when executed by the at least one data processor, implement operations comprising:
receiving a first term as input to a social media data query;
determining a related term based on a predictive model trained on historical user interactions with a social media dataset of topics, the historical user interactions including query terms and associated topics returned as query results, the related term being related to the first term; and
providing the related term to a user interface to prompt a user to include the related term in the social media data query.

9. The system of claim 8, the operations further comprising:
determining a distance between the first term and each of a plurality of clusters of social media datasets clustered according to predetermined labels, the distance calculated in a vector space,
wherein determining the related term is further based on one of the predetermined labels that is associated with a cluster that is a shortest distance to the first term in the vector space.

10. The system of claim 9, wherein determining the related term is based on a weighted combination of an output of the predictive model and the one of the predetermined labels that is associated with the cluster that is the shortest distance to the first term in the vector space.

11. The system of claim 9, wherein the clustered datasets are clustered from a database of social media mentions including text documents relevant to the query

12. The system of claim 8, wherein the user interface provides a query wizard interface to define the social media data query based on brands, products, and media terms.

13. The system of claim 8, the operations further comprising:
determining attributes associated with the related term, the attributes characterizing whether the historical user interactions associated with the related term were associated with at least one of: hashtag, at mention, title, uniform resource locator, and author.

15. A non-transitory computer program product storing instructions, which when executed by at least one data processor of at least one computing system, implement operations comprising:
receiving a first term as input to a social media data query;
determining a related term based on a predictive model trained on historical user interactions with a social media dataset of topics, the historical user interactions including query terms and associated topics returned as query results, the related term being related to the first term; and
providing the related term to a user interface to prompt a user to include the related term in the social media data query.

16. The computer program product of claim 15, the operations further comprising:
determining a distance between the first term and each of a plurality of clusters of social media datasets clustered according to predetermined labels, the distance calculated in a vector space,
wherein determining the related term is further based on one of the predetermined labels that is associated with a cluster that is a shortest distance to the first term in the vector space.

17. The computer program product of claim 16, wherein determining the related term is based on a weighted combination of an output of the predictive model and the one of the predetermined labels that is associated with the cluster that is the shortest distance to the first term in the vector space.

18. The computer program product of claim 16, wherein the clustered datasets are clustered from a database of social media mentions including text documents relevant to the query

19. The computer program product of claim 15, wherein the user interface provides a query wizard interface to define the social media data query based on brands, products, and media terms.

20. The computer program product of claim 15, the operations further comprising:
determining attributes associated with the related term, the attributes characterizing whether the historical user interactions associated with the related term were associated with at least one of: hashtag, at mention, title, uniform resource locator, and author.
